(19) United States
(12) Patent Application Publication
(10) Pub. No.: US 2009/0090871 A1
(43) Pub. Date: Apr. 9, 2009

(54) Radiation treatment system with a beam control magnet

(76) Inventors: Dirk Diehl, Erlangen (DE); Rene Gumbrecht, Herzogenaurach (DE); Eva Schneider, Nurnberg (DE)

Correspondence Address: BRINKS HOFER GILSON & LIONE, P.O. BOX 10395, CHICAGO, IL, 60610, US

(21) Appl. No.: 12/284,372

(22) Filed: Sep. 22, 2008

(30) Foreign Application Priority Data
Sep. 28, 2007 (DE) 10 2007 046 508.6

(51) Int. Cl. H01J 3/14; H01J 5/18

(52) U.S. Cl. 250/396 R; 250/505.1

(57) ABSTRACT

A radiation treatment system with a beam control magnet for deflecting a beam of electrically charged particles along a curved particle path. The beam control magnet is subdivided along a parting plane perpendicular to the direction of the particle path into a first region and a second region. The quadrupole moments of the beam control magnet have different signs in the first region and the second region.

This application claims the benefit of DE 10 2007 046 508.6, filed Sep. 28, 2007, which is hereby incorporated by reference.

### BACKGROUND

The present embodiments relate to a radiation treatment system having a beam control magnet for deflecting a stream of electrically charged particles.

German Patent Application 10 2006 018 635.4, which was not published prior to the filing date of the present application, describes a radiation treatment system. The radiation treatment system includes a coil system. The coil system includes two saddle-shaped primary coils, with side parts elongated in the direction of the particle path and with end parts bent open relative to the beam control plane, two at least largely flat secondary coils, curved in bananalike fashion and disposed between the end parts of the primary coils, with side parts elongated in the direction of the particle path and with curved end parts that each surround one inner region, and two at least largely flat additional coils, curved in bananalike fashion and each disposed in the inner region of the respective secondary coil.

In particle therapy, ions of hydrogen (protons), carbon (C6+), or other elements are accelerated to high speeds (50 to 500 MeV/nucleon) and aimed at a tumor tissue that is to be treated. German Patent Disclosure DE 199 04 675 A1 and U.S. Pat. No. 4,870,287 A disclose a radiation treatment systems for medical therapy. The radiation treatment systems include a stationary particle source and a stationary accelerator for generating a high-energy particle beam. The high-energy particle beam is aimed at a region in a patient that is to be irradiated, such as a tumor tissue.

Since a region to be irradiated is a relatively large area, the region is scanned with the particle beam. By varying the particle energy, the penetration depth into the tissue can be adjusted. To attain a suitable lateral scanning motion at the site to be irradiated, the particle beam is deflected out of the original path by small angles in the region of the deflecting and beam control magnets. The deflection is compensated for again by the following deflection magnets in the beam direction, such that the beam strikes the site to be irradiated with a parallel offset.

From a medical standpoint, it is expedient to perform the radiation treatment of a tumor from different directions. The beam dose in the surrounding area (tissue), such as the area not to be treated, of the patient should be kept as slight as possible. By varying the angle of incidence, the radiation exposure in the surrounding tissue can be distributed over as large a volume as possible. Depending on the location of the region to be irradiated in the body of the patient, the direction from which the particle beam strikes the region to be irradiated can be selected such that the particle beam, along its way through the body of the patient, travels the shortest possible distance to the region to be irradiated.

To enable irradiation of the tumor from different directions, a movable magnet system guides and deflects the ion beam. The magnet system is adjustable in magnetic intensity, for adaptation to different particle energies. The variable magnet system can use electromagnets. For irradiating a patient from different directions, the particle beam is shot into a gantry along an axis that is predetermined by the accelerator, and the gantry is rotatable about the axis predetermined by the particle beam.

The gantry is a system of magnets for deflecting and focusing the beam of electrically charged particles, at different kinetic energies of the various particles, and the mounting and rotating mechanism required for mounting the magnets. The particle beam is deflected repeatedly from the beam's original direction by the gantry. After leaving the gantry, the particle beam strikes the region to be irradiated at a defined angle. Typically, the particle beam strikes the region to be irradiated at an angle of between 45° and 90°, relative to the axis of rotation of the gantry.

The gantry includes a frame. Beam control magnets are disposed on the frame. The beam control magnets are disposed on a frame in such a way that the particle beam emerging from the gantry always extends through a fixed region to be irradiated, known as the isocenter. An irradiation of a region to be treated can be done from a plurality of sides. The radiation dose in the region surrounding the isocenter can be distributed over the largest possible volume, and the radiation exposure outside the isocenter can be kept relatively slight.

For irradiating an extensive tumor, in addition to varying the particle energy and the angle at which the particle beam strikes the region to be irradiated, a variation of the lateral site coordinates at the target point of the particle beam is also desirable. For varying the site coordinates of the particle beam, scanner magnets are integrated with the gantry. The scanner magnets may be used to deflect the particle beam in a horizontal plane and a vertical plane, by small angles in each case. The deflections of the particle beam that are caused by the scanner magnets are compensated for, by the magnets that follow in the beam direction, in such a way that the particle beam leaves the gantry again in virtually parallel beams. The deflection of the particle beam, and in particular its deflection downstream of the scanner magnet in a final 45° or 90° deflection magnet, is effected by a dipole moment. Compensation for the defocusing caused by the scanner is effected by typically separate quadrupole moments. Quadrupole moments have the property of acting in a focusing manner in a first plane and in a defocusing manner in a second plane that is perpendicular to the first plane.

The position of the scanner magnets relative to the final 45° or 90° deflection magnet is defined in a virtually point-precise manner for focusing. Scanner magnets moreover occupy considerable space in the gantry of a pig and furthermore increase the weight of the rotatable gantry.

### SUMMARY AND DESCRIPTION

The present embodiments may obviate one or more of the drawbacks or limitations inherent in the related art. For example, in one embodiment, a radiation treatment system is flexible with regard to the positionability of the scanner magnets. In another example, a control beam has improved focusing properties.

In one embodiment, a particle beam passes through a beam control magnet after passing the scanner magnets and before the arrival at the isocenter, in such a way that the particle beam has a dipole moment that deflects the particle beam and two quadrupole moments that point in opposite directions. A beam of electrically charged particles is deflected by the dipole moment of the beam control magnet and focused by the quadrupole moments of the beam control magnet. The deflecting magnet of the radiation treatment system causes the beam of electrically charged particles to be focused in two directions, perpendicular to one another. A radiation treatment system with the beam control magnet is designed flexibly with regard to the positions of its scanner magnets.

A radiation treatment system may include a beam control magnet for deflecting a stream of electrically charged particles. Originating at a stationary particle source, the stream of electrically charged particles is deflected into an isocenter along a curved particle path, which defines a beam control plane and describes a circular segment with a radius R and an opening angle α. The beam control magnet has a coil system which does not use material that is ferromagnetic and affects beam control. The coil system has elongated curved individual coils along the particle path, which are disposed optionally in pairs, each in mirror symmetry to the beam control plane. The coil system includes: two saddle-shaped primary coils, with side parts elongated in the direction of the particle path and with end parts optionally bent open relative to the beam control plane, two at least largely flat secondary coils, curved in bananalike fashion and disposed between the end parts of the primary coils, with side parts elongated in the direction of the particle path and with curved end parts that each surround one inner region, and two at least largely flat additional coils, curved in bananalike fashion and each disposed in the inner region of the respective secondary coil.

The beam control magnet is subdivided into a first and second region along a parting plane, perpendicular to the direction of the particle path. The particle beam, originating at a particle source, passes through the first region before passing through the second region In the first region, the secondary coils and the additional coils are displaced in a first direction, parallel to the radius R, relative to the primary coils. In a second region, the secondary coils and the additional coils are displaced in a second direction, counter to the first direction, relative to the primary coils. The quadrupole moments of the beam control magnet have opposite signs in the first and second regions.

The radiation system may be used to focus the beam of electrically charged particles.

Compared to location of the primary and secondary coils in the first region, in the second region the primary coils and the secondary coils can be displaced in the first direction, into a position with a greater radius R. In the second region, the additional coil, compared to the location of the additional coil in the first region, can be displaced in the second direction, into a position with a smaller radius. The system includes an especially simple and effectively designed beam control magnet.

The beam control magnet of the radiation treatment system may have a quadrupole moment with a positive sign in the first region and a quadrupole moment with a negative sign in the second region. By the aforementioned disposition of the quadrupole moments, a radiation treatment system can be disclosed that has especially favorable focusing properties.

The radiation treatment system can have an X scanner magnet and a Y scanner magnet for lateral deflection of the particle beam at the site of the isocenter in an X direction and a Y direction perpendicular to X direction. The X scanner magnet and the Y scanner magnet can be disposed upstream, as viewed from the particle source, of the beam control magnet. The respective spacings from the beam control magnet can be adjustable by the coil system. In the radiation treatment system, the position of the X scanner magnet and the Y scanner magnet can be adjusted variably. A radiation treatment system with the beam control magnet is flexible in its construction.

The X scanner magnet and the Y scanner magnet can be combined into a common XY scanner magnet. The deflection of the particle beam in the X direction and in the Y direction is effected essentially at the same site. Because the two scanner magnets are combined into one common scanner magnet, an especially space-saving and compact radiation treatment system can be disclosed.

The XY scanner magnet can be an X scanner magnet or a Y scanner magnet that is rotatable about the axis of the particle path. One of the two scanner magnets can be dispensed with using the XY scanner magnet. Accordingly, the space and cost for the radiation treatment system is reduced.

The conductors of the individual coils of the beam control magnet of the radiation treatment system can be made from superconductor material, such as from LTC superconductor material or HTC superconductor material. A radiation treatment system with superconducting deflection magnets is lighter in weight and smaller than a radiation treatment system with conventionally embodied electromagnets. Because the radiation treatment system can be reduced in its size, there is a considerable cost advantage for such a radiation treatment system. LTC superconductor material is technologically easily mastered and can be suitably processed. HTC superconductor material is advantageous, since the effort and complexity for cooling for maintaining the superconduction is less.

The operating temperature of the conductors of the individual coils can be between 10 K and 40 K, preferably between 20 K and 30 K. In the aforementioned temperature ranges, the HTC superconductor material may have high critical current densities.

The particle beam can be a beam of C⁶⁺ particles. C⁶⁺ particles may be suited for radiation therapy, because of the absorption properties.

### BRIEF DESCRIPTION OF THE DRAWINGS

FIG. 1 shows a radiation treatment system;

FIG. 2 is a perspective view of a known beam control magnet;

FIG. 3 is a cross section through a known beam control magnet;

FIG. 4 is a longitudinal section through a different embodiment of a beam control magnet; and

FIGS. 5 and 6 each show a cross section through the beam control magnet of FIG. 4.

### DETAILED DESCRIPTION

Components corresponding to one another in the drawings are identified by the same reference numerals.

FIG. 1 shows a radiation treatment system 100 with a stationary particle source 101. Originating at the particle source 101, a beam of electrically charged particles is shot (guided) into a gantry along a particle path 102. The gantry includes a plurality of deflection and/or beam control magnets 104, 105, an X scanner magnet 106, and a Y scanner magnet 107. The gantry is rotatable about an axis A of rotation, so that the beam of electrically charged particles, along its particle path 102, upon the rotation of the gantry always intersects the axis A of rotation at a fixed point, the isocenter 103.

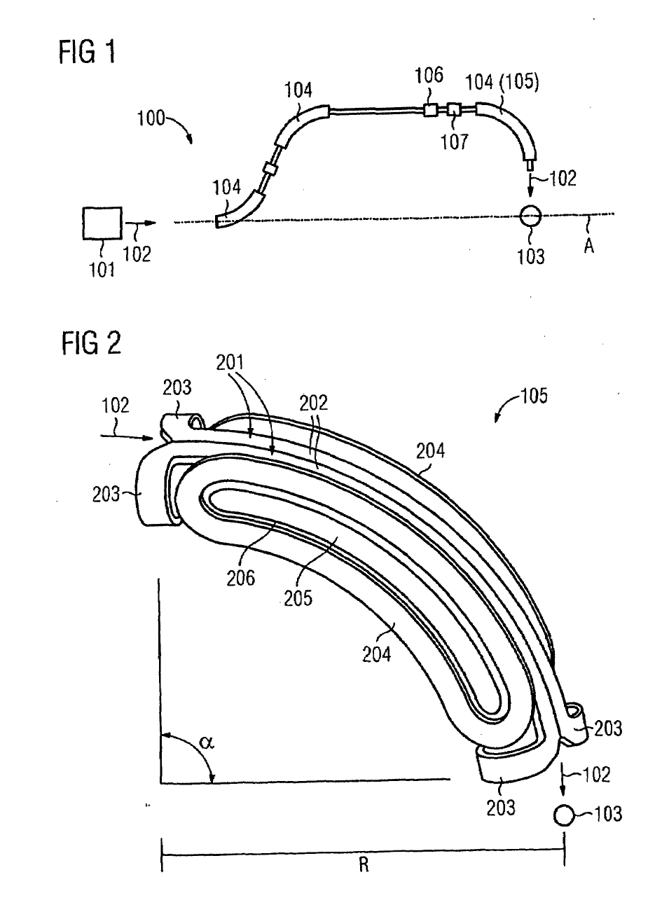

FIG. 2 shows a beam control magnet 105, in which components other than the coils of the magnet system have been left out. The beam control magnet 105 serves to deflect a beam of electrically charged particles along a particle path 102. The trajectory described by the charged particles along the particle path 102 may correspond to a circular segment having the radius R and the opening angle α. The beam of electrically charged particles is deflected into an isocenter 103.

The coil system of the deflection magnet 105 includes two primary coils 201 with elongated side parts 202 and end parts 203 that are bent open at the face end. One secondary coil 204 is located between two end parts 203, bent open at the face end, of the primary coils 201. The secondary coils 204 enclose an inner region 205, in which an additional coil 206 is located. The beam of electrically charged particles deflected along the particle path 102 defines a beam control plane SA.

The primary coils 201 in FIG. 2 may be inserted into a flat inner coil and a flat outer coil. The current feedback from the inner elongated side part 202 is effected through a side part over a shorter radius, and the current feedback of the outer elongated side part 202 is effected over a larger radius. The connection of the side parts 202 to the respective feedbacks is effected via flat semicircular arcs. If the beam control magnet is constructed completely of planar windings, then the saddle-shaped end parts 203 can also be omitted.

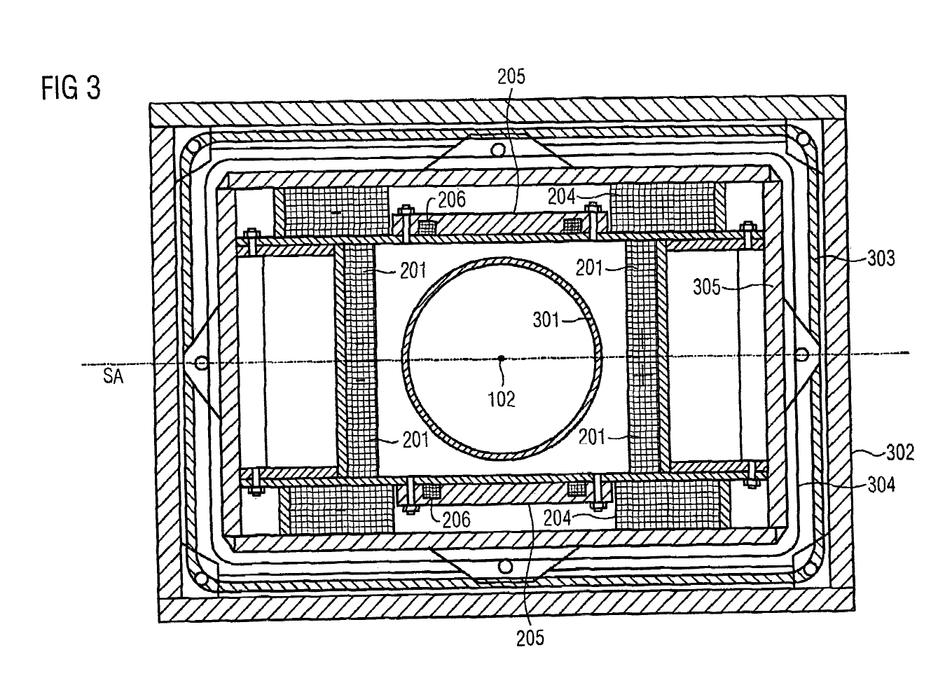

FIG. 3 shows a cross section through a control magnet 105, as indicated in FIG. 2. The coil system of the beam control magnet is constructed in mirror symmetry relative to the beam control plane SA. A beam of electrically charged particles is guided along its particle path 102 in a beam control tube 301. The primary coils 201, the secondary coils 204, and the additional coils 206 disposed in the inner region 205 of the secondary coils 204 are all located on both sides of the beam control tube 301. The coil system is mechanically retained by a mounting structure 305.

The coils of the coil system may be superconducting coils, which to maintain the superconduction must be cooled to low temperatures. The entire coil system, including the mounting structure 305, can be located in a cryostat 303. To improve the thermal insulation, especially with regard to heat radiation, a superinsulator 304 can additionally be located inside the cryostat 303. The entire system described is located inside a magnet housing 302.

As can be seen from FIG. 2, the coils of the coil system have a continuous curvature, for example, in the area of their elongated side regions. As can be seen from FIG. 3, the spacings of the individual coils from the particle path 102 but also from the beam control tube 301 are essentially constant over the entire length of the deflection magnet 105. The ratio of the spacings of the coils from one another is likewise essentially constant over the length of the beam control magnet 105.

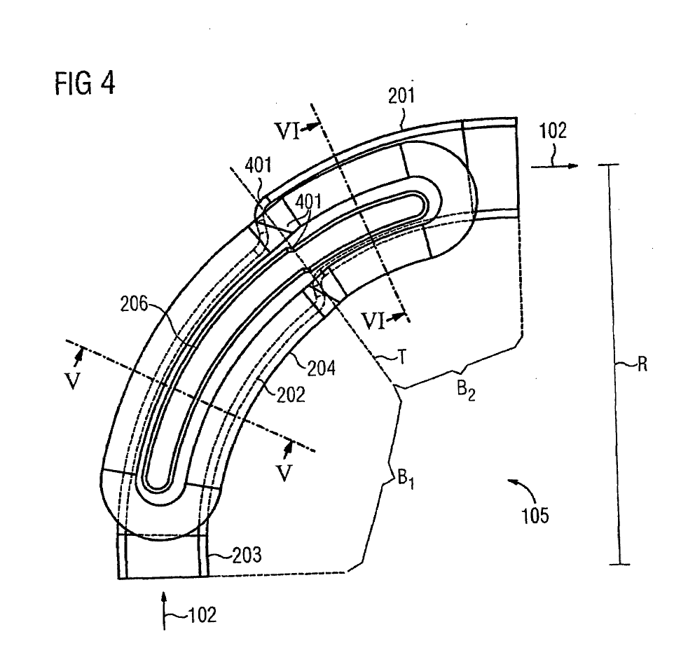

FIG. 4 shows one embodiment a beam control magnet 105. As shown, the beam control magnet 105 is subdivided into a first region B₁ and a second region B₂ along a parting plane T. The parting plane T is oriented vertically to the particle path 102. In terms of direction, the surface normal of the parting plane T corresponds to the site vector of the particle path 102 at the site of the parting plane T.

Both in the first region B₁ and in the second region B₂, the beam control magnet 105 shown in FIG. 4 have at least two primary coils 201, two secondary coils 204, and two additional coils 206. In the first region B₁, the secondary coils 204 and the additional coils 206 are displaced parallel to the radius R, compared to the primary coils 201. In the second region B₂, the secondary coils 204 and the additional coils 206 are displaced in a second direction R₂, opposite the first direction R₁, compared to the primary coils 201.

By the displacement of the coil system, it can be attained that the beam control magnet 105, in the exemplary embodiment shown in FIG. 4, has, in addition to the dipole moment necessary for deflecting the particle beam, two quadrupole moments that are opposite in terms of their direction. The quadrupole moment in the first region B₁ and the quadrupole moment in the second region B₂ differ in their sign.

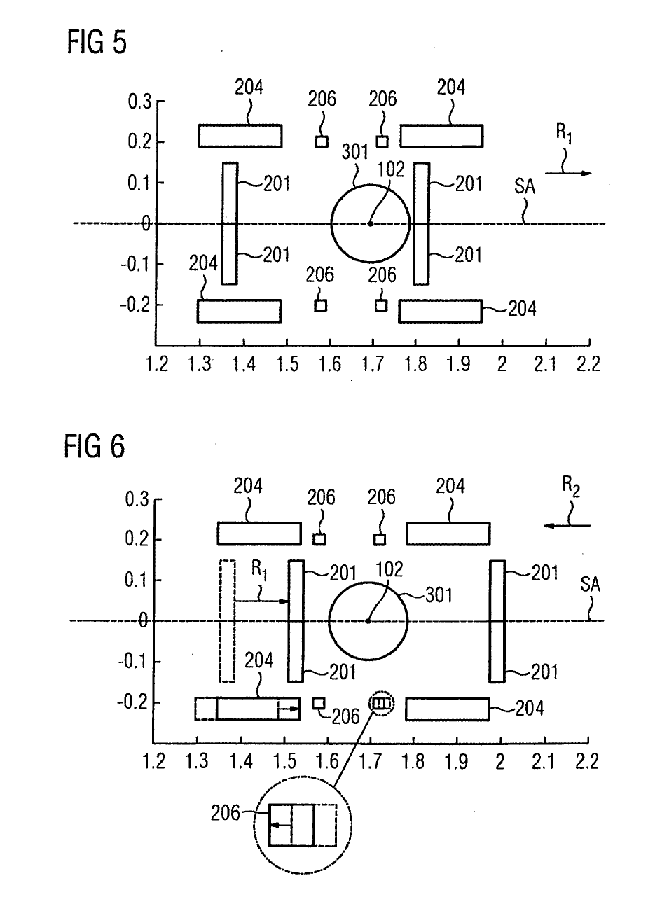

The displacement of the individual coils of the coil system becomes clear from two sections, shown in FIGS. 5 and 6, through the beam control magnet 105 shown in FIG. 4. FIG. 5 shows a section in the first region B₁ along the plane V-V, and FIG. 6 shows a section in the second region B₂ along the plane VI-VI.

FIG. 5 shows a cross section through the coil system of the beam control magnet of FIG. 4. Both the secondary coils 204 and the additional coils 206 are displaced in a direction R₁, compared to the primary coils 201. The displacement in the direction R₁ is effected parallel to the beam control plane SA.

FIG. 6 shows a further cross section through the coil system of the beam control magnet 105 of FIG. 4. The secondary coils 204 and the additional coils 206 are displaced in the second region B₂ in a second direction R₂, which is opposite the first direction R₁.

In an alternative embodiment, compared to the position of the primary coils in the first region B₁, the primary coils 201 in the second region B₂ are displaced in a direction R₁, as indicated in FIG. 6. The primary coils 201 and the secondary coils 204 may be displaced in the direction R₁. The additional coils 206, conversely, are displaced in a direction R₂ that is opposite the first direction R₁.

The displacement in terms of the position of the individual coils of the coil system of the beam control magnet 105 in the first region B₁ and the second region B₂ have the effect that the beam control magnet 105 has quadrupole moments of different signs in the first region B₁ and in the second region B₂.

The deflection of the beam of electrically charged particles is effected by the dipole moment of the beam control magnet 105. The quadrupole moments cause focusing of the particle beam, and the quadrupole moments compensate for the effect of the X scanner magnet and the Y scanner magnet 106, 107, respectively. In a radiation treatment system, the beam of electrically charged particles may be focused in two directions, perpendicular to one another. The focusing is accomplished with one and the same magnet, with which the beam of electrical particles is deflected. The position of the X scanner magnet 106 and Y scanner magnet 107, compared to the beam control magnet 105, and the spacings among the various scanner magnets along the particle path 102 are adjustable by the dimensioning of the quadrupole moments in the regions B₁ and B₂.

The X scanner magnet 106 and the Y scanner magnet 107 can be combined into one common XY scanner magnet. The X scanner magnet 106 or the Y scanner magnet 107 may be disposed rotatably about the particle path 102. The rotation of the field direction for the deflection in what is in that case the sole scanner magnet may be done mechanically. A single scanner magnet may include a plurality of pole pairs, for example, two pole pairs oriented perpendicular to one another, so that by way of the current supply ratio of the pole pairs, a field rotation may be effected in a purely electrical way and faster than a mechanical rotation. By a 90° rotation, for example, an X scanner magnet can in this way change over to a Y scanner magnet, or can attain the same effect. The radiation treatment system can be shortened considerably in size.

1. A radiation treatment system, comprising:
a stationary particle source that is operable to generate a beam of electrically charged particles;
a beam control magnet for deflecting the beam of electrically charged particles along a curved particle path in a beam control plane , the particle path having a circular segment with a radius R and an opening angle α into an isocenter, the beam control magnet includes a coil system which does not use ferromagnetic material that affects the beam control and that has elongated curved individual coils along the particle path which are each disposed in pairs in mirror symmetry to the beam control plane, the coil system including:
two saddle-shaped primary coils, with side parts elongated in the direction of the particle path and with end parts bent open relative to the beam control plane,
two at least largely flat secondary coils, curved in bananalike fashion and disposed between the end parts of the primary coils, with the side parts elongated in the direction of the particle path and with the end parts that each surround one inner region, and
two at least largely flat additional coils, curved in bananalike fashion and each disposed in the inner region of the respective secondary coil, wherein the beam control magnet is subdivided along a parting plane, perpendicular to the direction of the particle path, into a first and second region, and the particle beam, which originates at the particle source , passes through the first region before passing through the second region;
in the first region, the secondary coils and the additional coils are displaced in a first direction parallel to the radius compared to the primary coils, and in a second region the secondary coils and the additional coils are displaced in a second direction, counter to the first direction, compared to the primary coils; and
wherein the quadrupole moments of the beam control magnet have opposite signs in the first and second regions.

2. The radiation treatment system as defined by claim 1,
wherein, compared to the location of the primary coils and secondary coils in the first region, the primary coils and the secondary coils in the second region are displaced in the first direction, into a position with a greater radius; and
wherein, compared to a location of the additional coil in the first region, the additional coil in the second region is displaced in the second direction, into a position with a smaller radius.

3. The radiation treatment system as defined by claim 1, wherein each primary coil is divided into a flat inner coil and a flat outer coil, and a current feedback from the inner elongated side part is effected through a side part over a smaller radius, and the current feedback from the outer elongated side part is effected over a larger radius, and the connection of the inner side part to the current feedback is a flat semicircular arc.

4. The radiation treatment system as defined by claim 1, wherein a quadrupole moment with a positive sign is in the first region and a quadrupole moment with a negative sign is in the second region.

5. The radiation treatment system as defined by claim 1, further comprising an X scanner magnet and a Y scanner magnet for lateral deflection of the particle beam at the site of the isocenter in an X direction and a Y direction perpendicular to the X direction, and
wherein the X scanner magnet and the Y scanner magnet, viewed from the particle source, are disposed upstream of the beam control magnet, and a X scanner spacing from the beam control magnet and a Y scanner magnet spacing from the beam control magnet are adjustable using the coil system.

6. The radiation treatment system as defined by claim 5, wherein the X scanner magnet and the Y scanner magnet are combined into a XY scanner magnet, and the XY scanner magnet deflect the particle beam in the X direction and in the Y direction at the same site.

7. The radiation treatment system as defined by claim 6, wherein the XY scanner magnet is an X scanner magnet or a Y scanner magnet that is rotatable about the axis of the particle path.

8. The radiation treatment system as defined by claim 7, wherein the XY scanner magnet includes a plurality of pole pairs, with which the rotation of the field direction is effected purely electrically by the current supply ratio of the pole pairs to one another.

9. The radiation treatment system as defined by claim 1, wherein the conductors of the individual coils include metal LTC superconductor material.

10. The radiation treatment system as defined by claim 1, wherein the conductors of the individual coils include metal oxide HTC superconductor material.

11. The radiation treatment system as defined by claim 10, wherein an operating temperature of the conductors of the individual coils of between 10 K and 40 K.

12. The radiation treatment system as defined by claim 1, wherein the particle beam comprises C⁶⁺ particles.

13. The radiation treatment system as defined by claim 8, wherein the XY scanner magnet includes an even number of pole pairs.

14. The radiation treatment system as defined by claim 11, wherein an operating temperature of the conductors of the individual coils of between 20 K and 30 K.
